(19) United States
(12) Patent Application Publication
(10) Pub. No.: US 2022/0163448 A1
(43) Pub. Date: May 26, 2022

(54) TEMPORALLY-RESOLVED AND SPATIALLY-RESOLVED PUMP-PROBE CONTROL SYSTEM AND METHOD

(71) Applicant: BEIJING JIAOTONG UNIVERSITY, Beijing (CN)

(72) Inventors: Dawei HE, Haidian District (CN); Ang BIAN, Haidian District (CN); Yongsheng WANG, Haidian District (CN)

(21) Appl. No.: 17/489,402

(22) Filed: Sep. 29, 2021

(30) Foreign Application Priority Data
Nov. 26, 2020 (CN) 202011345392.7

(51) Int. Cl. G01N 21/63

(52) U.S. Cl. CPC G01N 21/636; G01N 2021/637

(57) ABSTRACT

The present disclosure provides a temporally-resolved and spatially-resolved pump-probe control system and a method. The system includes an ultrafast femtosecond laser device, an optical parametric oscillator, a displacement delay module, a micro-drive rotation module, an objective lens, a sample stage, a coupled photoelectric amplifier and a computer terminal. The control system of the present disclosure integrates a temporally-resolved pump-probe function and a temporally-resolved and spatially-resolved pump-probe function. The present disclosure can realize pump-probe temporally-resolved scanning, one-dimensional temporally-resolved and spatially-resolved scanning, and two-dimensional temporally-resolved and spatially-resolved scanning under full-automatic control, and real-time data is visualized and synchronously written into batch files. The present disclosure aims to reduce complexity of temporally-resolved and spatially-resolved scanning, shorten a test period, improve probe efficiency, and ensure stability and reliability of data results.

### CROSS REFERENCE TO RELATED APPLICATION(S)

This patent application claims the benefit and priority of Chinese Patent Application No. 202011345392.7 filed on Nov. 26, 2020, the disclosure of which is incorporated by reference herein in its entirety as part of the present application.

### TECHNICAL FIELD

The present disclosure relates to the technical field of lasers, particularly relates to the technical field of ultrafast laser pump-probes, and specifically relates to a temporally-resolved and spatially-resolved pump-probe control system and method.

### BACKGROUND ART

The pump-probe technique is an important technique applied in the field of ultrafast laser, which is capable of probing internal micro-dynamic information of semiconductor materials and semiconductor photoelectronic devices via interaction between light and matter in a non-contact manner. In particular, the temporally-resolved and spatially-resolved pump-probe technique can capture the whole process, from stimulated emission to recombination, of carriers at certain points on samples, but also collect the diffusion status of the carriers subjected to stimulated emission in planes of the samples, which plays a crucial role in thorough comprehension of internal mechanisms of the semiconductor photoelectronic devices. However, the current ultrafast laser pump-probe technique is mainly temporally-resolved pump-probe technique, and the temporally-resolved and spatially-resolved pump-probe technique has been restricted in use range and practicality due to complicated operation, poor stability, excessively high time consumption and other problems.

### SUMMARY

In view of the defects existing in the prior art, an object of the present disclosure is to provide a temporally-resolved and spatially-resolved pump-probe control system and method, which can realize automatic temporally-resolved and spatially-resolved pump-probe scanning, are convenient and easy to use, and improve test efficiency, stability and precision.

In order to achieve the above purpose, the present disclosure employs the following technical solutions:

the temporally-resolved and spatially-resolved pump-probe control system includes an ultrafast femtosecond laser device, an optical parametric oscillator, a displacement delay module, a micro-drive rotation module, an objective lens, a sample stage, a photoelectric coupler amplifier and a computer terminal;

the ultrafast femtosecond laser device serves as an ultrafast femtosecond pulse laser light source and is used for emitting a beam of femtosecond pulse laser;

the optical parametric oscillator is configured to change a wavelength of the femtosecond pulse laser and divide the femtosecond pulse laser into two lasers which serve as a pump laser and a probe laser respectively;

the displacement delay module includes a displacement delay master controller, an electric displacement base and a retro-reflector, the retro-reflector being arranged above the electric displacement base, the electric displacement base being connected to the displacement delay master controller, and the displacement delay master controller being connected to the computer terminal; the computer terminal is used to control a movement of the electric displacement base by means of the displacement delay master controller to accurately control a position of the retro-reflector, so as to process an optical path of one of the pump laser and the probe laser;

the computer terminal is further configured to read movement data of the electric displacement base in real time;

the micro-drive rotation module includes a micro-drive rotation controller and two reflectors, where each reflector includes two electric knobs, that is, an electric knob X and an electric knob Y, the electric knob Y being used for adjusting pitch of the reflector, and the electric knob X being used for adjusting a horizontal rotation angle of the reflector;

four interfaces with serial numbers 1, 2, 3 and 4 of the micro-drive rotation controller are connected to four electric knobs, the micro-drive rotation controller is further connected to the computer terminal, the computer terminal is configured to control the pitch and the horizontal rotation angle of the reflector by means of the micro-drive rotation controller, so as to adjust an angle, at which one laser processed through the displacement delay module enters the objective lens, and an angle, at which the other laser enters the objective lens, such that relative positions of a pump laser spot and a probe laser spot can be adjusted;

the computer terminal is further configured to read the pitch and the horizontal rotation angle of the reflector in real time;

the objective lens is configured to focus two lasers processed through the micro-drive rotation module onto the sample stage; and

the photoelectric coupler amplifier is configured to transmit the probe laser reflected or transmitted by the sample stage to the computer terminal.

The method based on a temporally-resolved and spatially-resolved pump-probe control system includes:

step S1, firstly, adjusting a pump laser and a probe laser to coincide at a sample stage, so as to ensure that optical path differences of the pump laser and the probe laser are equal; and

determining starting and ending time of pure temporally-resolved scanning and a relative position of temporally-resolved and spatially-resolved scanning.

step S2, initializing a program and parameters: starting Laboratory Virtual Instrument Engineering Workbench (LabVIEW) program and entering a working interface, and selecting test content comprising pure temporally-resolved scanning and temporally-resolved and spatially-resolved scanning; sequentially inputting a data file storage path and a new data file name, starting and ending positions, a displacement direction, a displacement step length and a displacement time interval of a retro-reflector, and serial numbers, starting and ending positions and rotation frequency of electric knobs on a reflector; and saving initial parameters; and

pre-running the program: sequentially reading the initial parameters, and confirming that various hardware devices are connected and operate normally; setting the retro-reflector and the reflectors at zero positions, such that the pump laser and the probe laser coincide and have the same optical path to complete initialization; and clicking a button Save, such that when the program is executed next time, data are automatically written into the preset path.

S3, running the program: executing running of the program, reading the initial parameters, writing them into a log file, carrying out pure temporally-resolved scanning or temporally-resolved and spatially-resolved scanning, displaying, in real time, data values and a time-varying image of the data values, and synchronously writing the data into a text file.

a) in a case of pure temporally-resolved scanning: controlling, by the program, the retro-reflector to move to a displacement starting point A, and to move step by step according to the preset displacement direction and the displacement time interval, entering an R loop, and after each step is finished, determining, by the program, whether the retro-reflector reaches a displacement ending point B; under the condition that a position t value of the retro-reflector is less than or equal to a B value, repeating the R loop, moving the retro-reflector continuously, and ending the R loop until the retro-reflector reaches the point B; and making the retro-reflector return, in one step, to the zero position, and ending;

b) in a case of one-dimensional temporally-resolved and spatially-resolved scanning: controlling, by the program, the electric knob X on the reflector to rotate, in one step, to a scanning starting point x1, and specifically, moving a probe laser spot to the scanning starting point x1; entering a Q loop, moving the retro-reflector to the displacement starting point A step by step, entering the R loop in pure temporally-resolved scanning, ending the R loop until the retro-reflector reaches the displacement ending point B, and making the retro-reflector return to the displacement starting point A; moving the laser spot once as the electric knob X is rotated by one step, and determining, by the program, whether the electric knob X reaches a rotating ending point x2; under the condition that an x value of the electric knob X is less than or equal to x2, repeating the R loop; in this way, carrying out pure temporally-resolved scanning at each laser spot position, and ending the Q loop until the electric knob X reaches the rotating ending point x2 and the laser spot reaches an x2 position; and making the electric knob X return to a rotating zero position, making the retro-reflector return to the zero position, and ending; and

c) in a case of two-dimensional temporally-resolved and spatially-resolved scanning: controlling, by the program, the electric knob X and the electric knob Y on the reflector to rotate, in one step, to a scanning starting point x1 and a scanning starting point y1, and specifically, moving the probe laser spot to a scanning starting point (x1, y1); entering a P loop, rotating the electric knob Y once every time the Q loop in one-dimensional temporally-resolved and spatially-resolved scanning in an x-axis direction is completed, determining, by the program, whether the electric knob Y reaches a rotating ending point y2, and under the condition that a y value of the electric knob Y is less than or equal to y2, repeating the Q loop; in this way, carrying out one-dimensional temporally-resolved and spatially-resolved scanning in the x-axis direction every time the laser spot moves by one step in a y-axis direction, that is the probe laser scanning line by line, where a displacement path is (x1, y1)-(x2, y1) . . . (x1, y2)-(x2, y2); ending the P loop until the electric knob Y reaches the rotating ending point y2 and the laser spot moves to a rotating ending point (x2, y2); and making the electric knob X and the electric knob Y return to rotating zero positions, making the retro-reflector return to the zero position, and ending;

S4, ending the program.

a) During running of the program, the program automatically reads a position of the retro-reflector on the displacement delay module and positions of the electric knobs on the micro-drive rotation module, compares the positions with initial parameters to determine whether to enter a next loop or end the loop to implement a next step, and ends until execution is completed;

b) during running of the program, an end button can be manually clicked at any time to forcibly end the program;

c) if a data connection problem occurs during running of the program or a computer program error occurs, the program automatically reports an error and ends; and

d) since the data is written in real time, error reporting does not affect saving of previous data.

In the control system of the present disclosure, a temporally-resolved pump-probe function and a temporally-resolved and spatially-resolved pump-probe function are integrated.

The system provided by the present disclosure presents a visual interface such that data information can be displayed, a running state can be monitored, and an error termination code can be reported in real time.

The temporally-resolved and spatially-resolved pump-probe control system and method provided in the present disclosure can realize an efficient temporally-resolved and spatially-resolved pump-probe, and offer the advantages of simple operation, high integration level, real-time display, data batch processing and the like.

According to the present disclosure, automatic temporally-resolved and spatially-resolved pump-probe scanning can be implemented by controlling the temporally-resolved and spatially-resolved pump-probe control system, and the temporally-resolved and spatially-resolved pump-probe is realized by controlling the displacement delay module and the micro-drive rotation module.

### BRIEF DESCRIPTION OF THE DRAWINGS

The present disclosure will be described with reference to the following drawings:

FIG. 1 is a block diagram of a temporally-resolved and spatially-resolved pump-probe control system in accordance with the present disclosure.

FIG. 2 is a flow diagram of a method in accordance with the present disclosure.

### DETAILED DESCRIPTION OF THE EMBODIMENTS

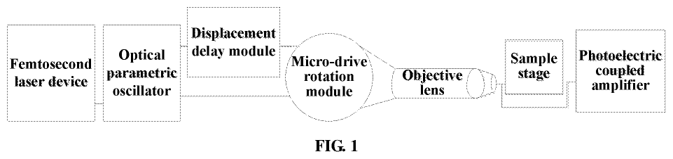

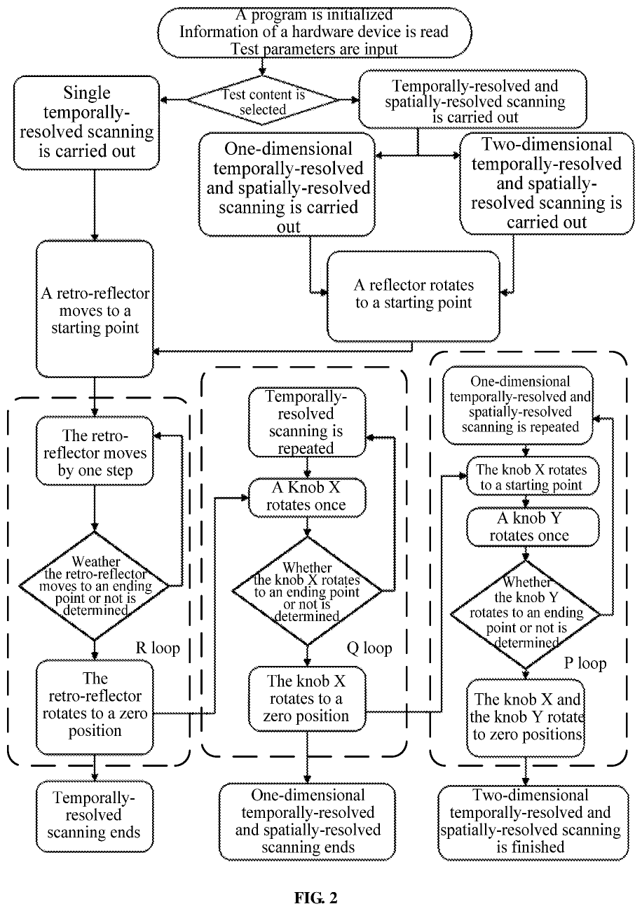

The present disclosure will be further described in detail with reference to FIGS. 1 and 2.

A temporally-resolved and spatially-resolved pump-probe control system in the embodiments of the present disclosure includes an ultrafast femtosecond laser device, an optical parametric oscillator, a displacement delay module, a micro-drive rotation module, an objective lens, a sample stage, a photoelectric coupler amplifier and a computer terminal.

The ultrafast femtosecond laser device serves as an ultrafast femtosecond pulse laser light source and is used for emitting a beam of femtosecond pulse laser;

The optical parametric oscillator is used to change a wavelength of the femtosecond pulse laser and dividing the femtosecond pulse laser into two lasers which serve as a pump laser and a probe laser respectively.

The displacement delay module includes a displacement delay master controller, an electric displacement base and a retro-reflector. The retro-reflector is arranged above the electric displacement base, the electric displacement base is connected to the displacement delay master controller, which in turn is connected to the computer terminal. The computer terminal is used to control a movement of the electric displacement base by means of the displacement delay master controller to accurately control the position of the retro-reflector, so as to process an optical path of one of the pump laser and the probe laser.

The computer terminal is further configured to read movement data of the electric displacement base in real time.

The micro-drive rotation module includes a micro-drive rotation controller and two reflectors, where each reflector includes two electric knobs, that is, an electric knob X and an electric knob Y. The electric knob Y is used to adjust pitch of the reflector, and the electric knob X is used to adjust a horizontal rotation angle of the reflector.

Four interfaces with serial numbers 1, 2, 3 and 4 of the micro-drive rotation controller are connected to four electric knobs, and the micro-drive rotation controller is further connected to the computer terminal. The computer terminal is used to control the pitch and the horizontal rotation angle of the reflector by means of the micro-drive rotation controller, so as to adjust an angle, at which one laser processed through the displacement delay module enters the objective lens, and an angle, at which the other laser enters the objective lens, such that relative positions of a pump laser spot and a probe laser spot may be adjusted.

The computer terminal is further used for reading the pitch and the horizontal rotation angle of the reflector in real time.

The objective lens is used for focusing the two lasers processed through the micro-drive rotation module onto the sample stage.

The photoelectric coupler amplifier is used for transmitting the probe laser reflected or transmitted by the sample stage to the computer terminal.

A method based on a temporally-resolved and spatially-resolved pump-probe control system includes the following steps.

In step S1, firstly, a pump laser and a probe laser are adjusted to coincide at a sample stage, so as to ensure that optical path differences of the pump laser and the probe laser are equal, and starting and ending time of pure temporally-resolved scanning and a relative position of spatially-resolved scanning are determined.

In step S2, a program and parameters are initialized: starting Laboratory Virtual Instrument Engineering Workbench (LabVIEW) program and entering a working interface, and selecting test content including pure temporally-resolved scanning and temporally-resolved and spatially-resolved scanning; sequentially inputting a data file storage path and a new data file name, starting and ending positions, a displacement direction, a displacement step length and a displacement time interval of the retro-reflector, and serial numbers, starting and ending positions and the number of rotation of electric knobs on a reflector; and storing initial parameters; and

pre-running the program: sequentially reading the initial parameters, and confirming that various hardware devices are connected and operate normally; setting the retro-reflector and the reflectors at zero positions; at this time, the pump laser and the probe laser coincide and have the same optical path, and initialization is finished; and clicking a button Save, such that when the program is executed next time, data are automatically written into the preset path.

In step S3, the program is run: executing running of the program, reading the initial parameters, writing data into a log file, carrying out pure temporally-resolved scanning or temporally-resolved and spatially-resolved scanning, displaying data values and a time-varying image of the data values in real time, and synchronously writing the data into a text file.

a) In a case of pure temporally-resolved scanning: controlling, by the program, the retro-reflector to move to a displacement starting point A, and to move step by step according to the preset displacement direction and the displacement time interval to enter an R loop, and after each step is finished, determining, by the program, whether the retro-reflector reaches a displacement ending point B; under the condition that a position t value of the retro-reflector is less than or equal to a B value, repeating the R loop, moving the retro-reflector continuously, and ending the R loop until the retro-reflector reaches the point B; and making the retro-reflector return, in one step, to the zero position, and ending;

b) In a case of one-dimensional temporally-resolved and spatially-resolved scanning: controlling, by the program, the electric knob X on the reflector to rotate, in one step, to a scanning starting point x1, and specifically, moving a probe laser spot to the scanning starting point x1; entering a Q loop, moving the retro-reflector to the displacement starting point A step by step, entering the R loop in pure temporally-resolved scanning, ending the R loop until the retro-reflector reaches the displacement ending point B, and making the retro-reflector return to the displacement starting point A; move the laser spot once as the electric knob X is rotated by one step, and determining, by the program, whether the electric knob X reaches a rotating ending point x2; under the condition that an x value of the electric knob X is less than or equal to x2, repeating the R loop; in this way, carrying out pure temporally-resolved scanning at each laser spot position, and ending the Q loop until the electric knob X reaches the rotating ending point x2 and the laser spot reaches an x2 position; and making the electric knob X return to a rotating zero position, making the retro-reflector return to the zero position, and ending; and

c) In a case of two-dimensional temporally-resolved and spatially-resolved scanning: controlling, by the program, the electric knob X and the electric knob Y on the reflector to rotate, in one step, to a scanning starting point x1 and a scanning starting point y1, and specifically, moving the probe laser spot to a scanning starting point (x1, y1); entering a P loop, rotating the electric knob Y once every time the Q loop in one-dimensional temporally-resolved and spatially-resolved scanning in an x-axis direction is completed, determining, by the program, whether the electric knob Y reaches a rotating ending point y2, and under the condition that a y value of the electric knob Y is less than or equal to y2, repeating the Q loop; in this way, carrying out one-dimensional temporally-resolved and spatially-resolved scanning in the x-axis direction every time the laser spot moves by one step in a y-axis direction, where a displacement path is (x1, y1)-(x2, y1) . . . (x1, y2)-(x2, y2); ending the P loop until the electric knob Y reaches the rotating ending point y2 and the laser spot moves to a rotating ending point (x2, y2); and making the electric knob X and the electric knob Y return to rotating zero positions, making the retro-reflector return to the zero position, and ending.

In step S4, the program is ended.

a) When the program is executed, the program automatically reads a position of the retro-reflector on the displacement delay module and positions of the electric knobs on the micro-drive rotation module, compares the positions with initial parameters to determine whether to enter a next loop or end the loop to implement a next step, and ends until implementation is completed.

b) When the program is executed, an end button may be manually clicked at any time to forcibly end the program.

c) When the program is executed, if a data connection problem occurs or a computer program error occurs, the program will automatically report an error and end.

d) Since the data is written in real time, error reporting does not affect storage of previous data.

The content not described in detail in the description belongs to the prior art well known to those skilled in the art.

What is claimed is:

1. A temporally-resolved and spatially-resolved pump-probe control system, comprising: an ultrafast femtosecond laser device, an optical parametric oscillator, a displacement delay module, a micro-drive rotation module, an objective lens, a sample stage, a photoelectric coupler amplifier and a computer terminal, wherein
the ultrafast femtosecond laser device serves as an ultrafast femtosecond pulse laser light source and is used for emitting a beam of femtosecond pulse laser;
the optical parametric oscillator is configured to change a wavelength of the femtosecond pulse laser and divide the femtosecond pulse laser into two lasers which serve as a pump laser and a probe laser respectively;
the displacement delay module comprises a displacement delay master controller, an electric displacement base and a retro-reflector, the retro-reflector being arranged above the electric displacement base, the electric displacement base being connected to the displacement delay master controller, and the displacement delay master controller being connected to the computer terminal; the computer terminal is used to control a movement of the electric displacement base by means of the displacement delay master controller to accurately control a position of the retro-reflector, so as to process an optical path of one of the pump laser and the probe laser;
the computer terminal is further configured to read movement data of the electric displacement base in real time;
the micro-drive rotation module comprises a micro-drive rotation controller and two reflectors, wherein each reflector comprises two electric knobs, that is, an electric knob X and an electric knob Y, the electric knob Y being used for adjusting pitch of the reflector, and the electric knob X being used for adjusting a horizontal rotation angle of the reflector;
four interfaces with serial numbers 1, 2, 3 and 4 of the micro-drive rotation controller are connected to four electric knobs, the micro-drive rotation controller is further connected to the computer terminal, the computer terminal is configured to control the pitch and the horizontal rotation angle of the reflector by means of the micro-drive rotation controller, so as to adjust an angle, at which one laser processed through the displacement delay module enters the objective lens, and an angle, at which the other laser enters the objective lens, such that relative positions of a pump laser spot and a probe laser spot can be adjusted;
the computer terminal is further configured to read the pitch and the horizontal rotation angle of the reflector in real time;
the objective lens is configured to focus two lasers processed through the micro-drive rotation module onto the sample stage; and
the photoelectric coupler amplifier is configured to transmit the probe laser reflected or transmitted by the sample stage to the computer terminal.

2. A method based on the temporally-resolved and spatially-resolved pump-probe control system according to claim 1, comprising:
step S1, firstly, adjusting a pump laser and a probe laser to coincide at a sample stage, so as to ensure that optical path differences of the pump laser and the probe laser are equal; and determining starting and ending time of pure temporally-resolved scanning and a relative position of temporally-resolved and spatially-resolved scanning;
step S2, initializing a program and parameters: starting Laboratory Virtual Instrument Engineering Workbench (LabVIEW) program and entering a working interface, and selecting test content comprising pure temporally-resolved scanning and temporally-resolved and spatially-resolved scanning; sequentially inputting a data file storage path and a new data file name, starting and ending positions, a displacement direction, a displacement step length and a displacement time interval of a retro-reflector, and serial numbers, starting and ending positions and rotation frequency of electric knobs on a reflector; and saving initial parameters; and
pre-running the program: sequentially reading the initial parameters, and confirming that various hardware devices are connected and operate normally; setting the retro-reflector and the reflectors at zero positions, such that the pump laser and the probe laser coincide and have the same optical path to complete initialization; and clicking a button Save, such that when the program is executed next time, data are automatically written into the preset data file storage path;
S3, running the program: executing running of the program, reading the initial parameters, writing them into a log file, carrying out pure temporally-resolved scanning or temporally-resolved and spatially-resolved scanning, displaying, in real time, data values and a time-varying image of the data values, and synchronously writing the data into a text file; and
S4, ending the program.

3. The method according to claim 2, wherein S3 specifically comprises:
a) in a case of pure temporally-resolved scanning: controlling, by the program, the retro-reflector to move to a displacement starting point A, and to move step by step according to the preset displacement direction and the displacement time interval, entering an R loop, and after each step is finished, determining, by the program, whether the retro-reflector reaches a displacement ending point B; under the condition that a position t value of the retro-reflector is less than or equal to a B value, repeating the R loop, moving the retro-reflector continuously, and ending the R loop until the retro-reflector reaches the point B; and making the retro-reflector return, in one step, to the zero position, and ending;
b) in a case of one-dimensional temporally-resolved and spatially-resolved scanning: controlling, by the program, the electric knob X on the reflector to rotate, in one step, to a scanning starting point x1, and specifically, moving a probe laser spot to the scanning starting point x1; entering a Q loop, moving the retro-reflector to the displacement starting point A step by step, entering the R loop in pure temporally-resolved scanning, ending the R loop until the retro-reflector reaches the displacement ending point B, and making the retro-reflector return to the displacement starting point A; moving the laser spot once as the electric knob X is rotated by one step, and determining, by the program, whether the electric knob X reaches a rotating ending point x2; under the condition that an x value of the electric knob X is less than or equal to x2, repeating the R loop; in this way, carrying out pure temporally-resolved scanning at each laser spot position, and ending the Q loop until the electric knob X reaches the rotating ending point x2 and the laser spot reaches an x2 position; and making the electric knob X return to a rotating zero position, making the retro-reflector return to the zero position, and ending; and
c) in a case of two-dimensional temporally-resolved and spatially-resolved scanning: controlling, by the program, the electric knob X and the electric knob Y on the reflector to rotate, in one step, to a scanning starting point x1 and a scanning starting point y1, and specifically, moving the probe laser spot to a scanning starting point (x1, y1); entering a P loop, rotating the electric knob Y once every time the Q loop in one-dimensional temporally-resolved and spatially-resolved scanning in an x-axis direction is completed, determining, by the program, whether the electric knob Y reaches a rotating ending point y2, and under the condition that a y value of the electric knob Y is less than or equal to y2, repeating the Q loop; in this way, carrying out one-dimensional temporally-resolved and spatially-resolved scanning in the x-axis direction every time the laser spot moves by one step in a y-axis direction, wherein a displacement path is (x1, y1)-(x2, y1) . . . (x1, y2)-(x2, y2); ending the P loop until the electric knob Y reaches the rotating ending point y2 and the laser spot moves to a rotating ending point (x2, y2); and making the electric knob X and the electric knob Y return to rotating zero positions, making the retro-reflector return to the zero position, and ending.

4. The method according to claim 3, wherein during running of the program, the program automatically reads a position of the retro-reflector on the displacement delay module and positions of the electric knobs on the micro-drive rotation module, compares the positions with initial parameters to determine whether to enter a next loop or end the loop to implement a next step, and ends until execution is completed.

5. The method according to claim 2, wherein during running of the program, an end button can be manually clicked at any time to forcibly end the program.

6. The method according to claim 2, wherein if a data connection problem occurs during running of the program or a computer program error occurs, the program automatically reports an error and ends; and since the data is written in real time, error reporting does not affect saving of previous data.
